(19) United States
(12) Patent Application Publication
(10) Pub. No.: US 2016/0279018 A1
(43) Pub. Date: Sep. 29, 2016

(54) Roller Apparatus and Method with Temperature Control

(71) Applicant: CONSUMING FIRE FITNESS, LLC, Truckee, CA (US)

(72) Inventors: Ryan Egan, Truckee, CA (US); Stephen O. Hoyt, Truckee, CA (US)

(73) Assignee: CONSUMING FIRE FITNESS, LLC, Truckee, CA (US)

(21) Appl. No.: 14/671,417

(22) Filed: Mar. 27, 2015

(51) Int. Cl. A61H 15/02

(52) U.S. Cl. CPC A61H 15/02; A61H 2201/0207

(57) ABSTRACT

A roller for therapy with a temperature control to enable a user to combine the benefits of heat or cold with the use of a roller. The roller comprises a generally cylindrically shaped roller body, a heating element, fluid conducting elements, a power source, and a hollow core that houses components including the power source. The heating and cooling elements are electric and are configured within the housing or in an external component in different embodiments of the apparatus. Temperature control is available to the user through an interface configured on the housing or in an external component in different embodiments of the apparatus.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

The present invention relates generally to roller devices for use in physical therapy, exercise, stretching, massage and for a variety of other purposes to improve and maintain a healthy body. Prior art rollers are known in the art. Examples are shown in U.S. Pat. No. 8,337,437 entitled “System and Methods for Promoting Health” to Hitzmann and published United States Patent Application Serial No. 2013/0231594 entitled “Heated Roller Apparatus.”

FIGS. 1A-C show a prior art foam roller 100 in use during exercises to work the back. In FIG. 1A, the user exercises the lower back area with the roller by sitting on the roller and slowly moving back and forth with the roller working the muscles in the buttocks and the lower back. In FIG. 1B, the roller is placed at the middle of the back and the user works the back muscles between the shoulders and the lower back. And, in FIG. 1C, the roller is placed below the shoulders and the user works the upper back and shoulder muscles. The roller may be used for a wide range of exercises to work muscles in all parts of the body as shown, for example, in U.S. Pat. No. 8,337,437. The descriptions and figures showing the exercises are incorporated herein for reference. It should be understood that a roller of the type and shape shown in FIGS. 1A-1C may also be used for an unlimited number of other exercises devised by physical therapists, trainers and other professionals who routinely work with people in the health industry.

FIG. 2 is a prior art 200 roller with perforations 205 to allow heat from a removable heating element in the core of the roller to be distributed through the perforations to reach the user's skin. Such a roller is described and shown in US Patent Publication 2013/0231594 referenced above.

A variety of other rollers are also shown in the prior art including those that provide heat and vibration during use. However, there is a need for an improved roller that alternatively provides heat or cooling during use and that is easy and safe to use. The present invention offers a unique combination of features that increases the flexibility of a roller to address the application of hot or cold temperatures during exercise. Numerous other advantages and features of the invention will become readily apparent from the detailed description of the embodiments of the invention, from the claims, and from the accompanying drawings.

### BRIEF DESCRIPTION OF THE DRAWINGS

For a better understanding of the present invention, and to describe its operation, reference will now be made, by way of example, to the accompanying drawings. The drawings show different embodiments of the present invention in which:

FIGS. 1A-C show a prior art roller in use for different exercises;

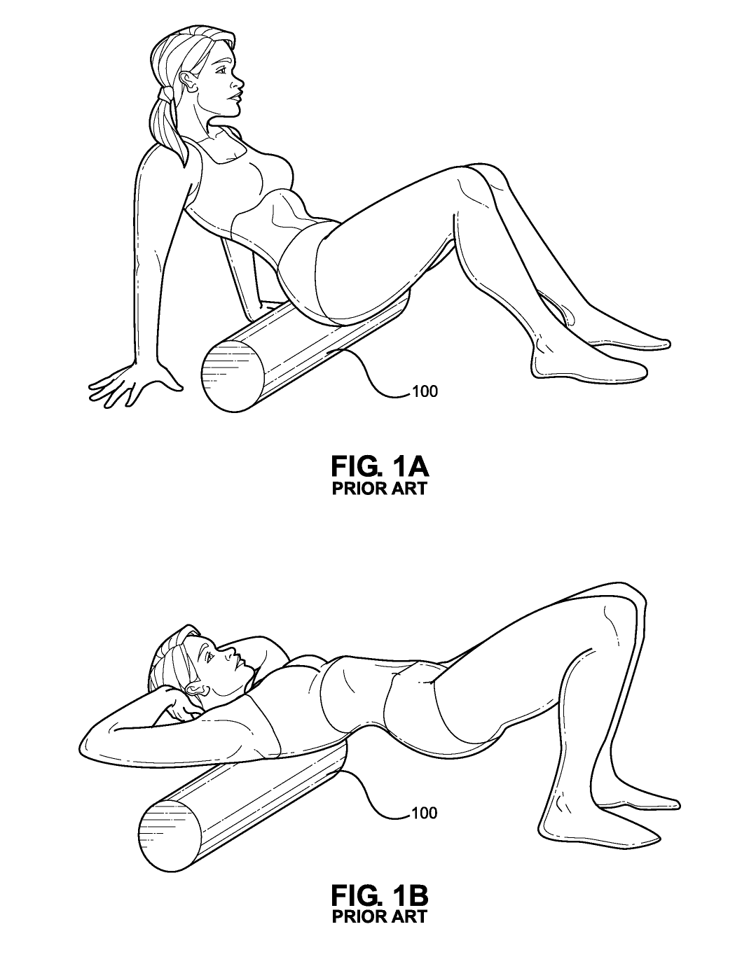

FIG. 2 shows a prior art roller with perforations and a heating element;

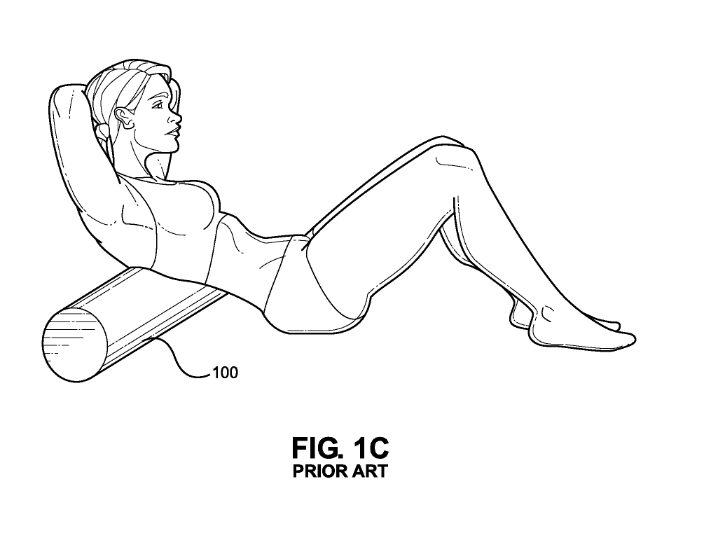

FIG. 3A-C show perspective views of a first embodiment of a roller of the present invention;

FIG. 4 shows internal components of a first embodiment of a roller of the present invention;

FIG. 5 is a cut-away view of a pump with a heating element;

FIGS. 6A-B show perspective views of a second embodiment of a roller of the present invention;

FIG. 7 shows internal components of a second embodiment of a roller of the present invention;

FIG. 8 is a perspective view of a third embodiment of a roller of the present invention on a heating station;

FIG. 9 shows the heating station of FIG. 8 without the roller;

FIGS. 10A-B are two perspective views of the heating element of the third embodiment of the roller of FIGS. 8-9; and

FIGS. 11A-E show views of a fourth embodiment of a roller of the present invention.

### DETAILED DESCRIPTION OF THE INVENTION

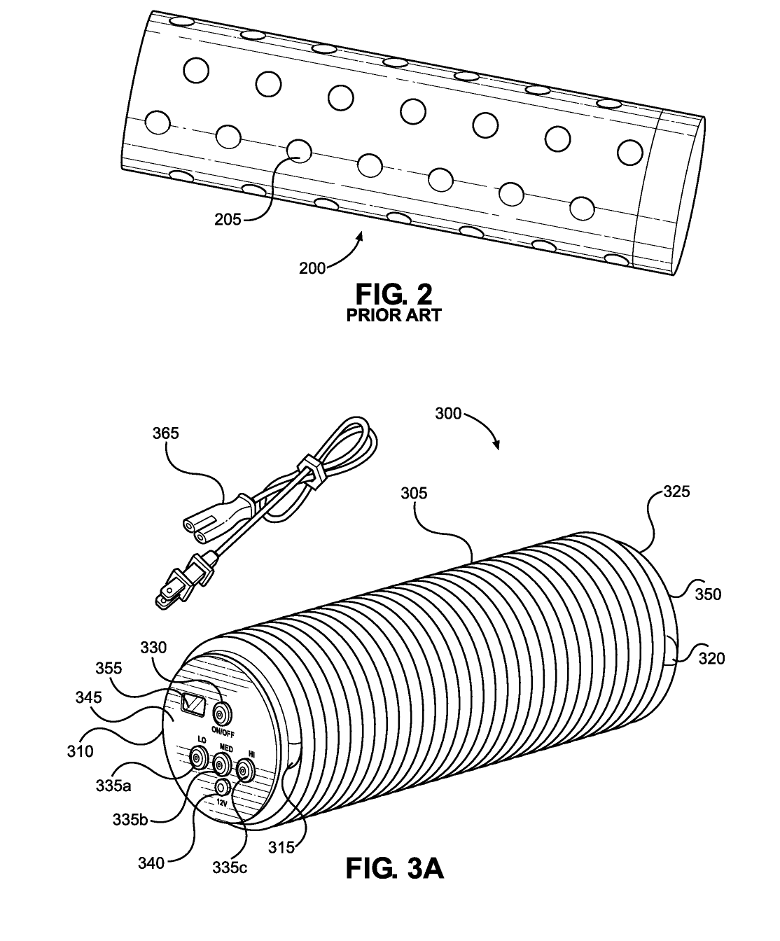

The present invention will now be described more fully with reference to the accompanying drawings. It should be understood that the invention may be embodied in many different forms and should not be construed as limited to the embodiments set forth herein. Throughout the FIGS. 3-11, like elements of the invention are referred to by the same reference numerals for consistency purposes.

FIGS. 3A-C are perspective views of a first embodiment of a roller 300 of the present invention. Roller 300 is generally cylindrical in shape and the exterior is covered with a hollow tubing 305. Hollow tubing may be flexible and is typically formed of malleable plastic, vinyl, polypropylene or another suitable material that deforms to a small degree along the sidewall when pressure is applied against it, but returns to its original form when the pressure is removed. Hollow tubing 305 has a diameter that is preferably in the range of approximately 11 mm to 16 mm and a wall thickness that is preferably in the range of approximately 2 mm to 4 mm.

Fluid circulates through hollow tubing 305 during use. Hollow tubing 305 is wound around the entire length of roller 300 starting at a first end 310 of roller 300 where an entry port 315 is positioned and extending in a tightly wound spiral configuration around the exterior of roller 300 to an exit port 320 at second end 325 of roller 300. The fluid in tubing 305 may be heated or cooled to provide heat or cooling to the skin and/or musculature of a user of roller 300. Entry port 315 and exit port 320 are formed of rigid material such as plastic and are either integrated in the body of roller 300 near end 310 and 315 respectively or configured to pass through a hole in the body of roller 300. Alternatively, ports 315, 320 may be integrated in or pass through a hole in end panels 345, 350 covering an interior portion of roller 300 at first end 310 and second end 325, respectively.

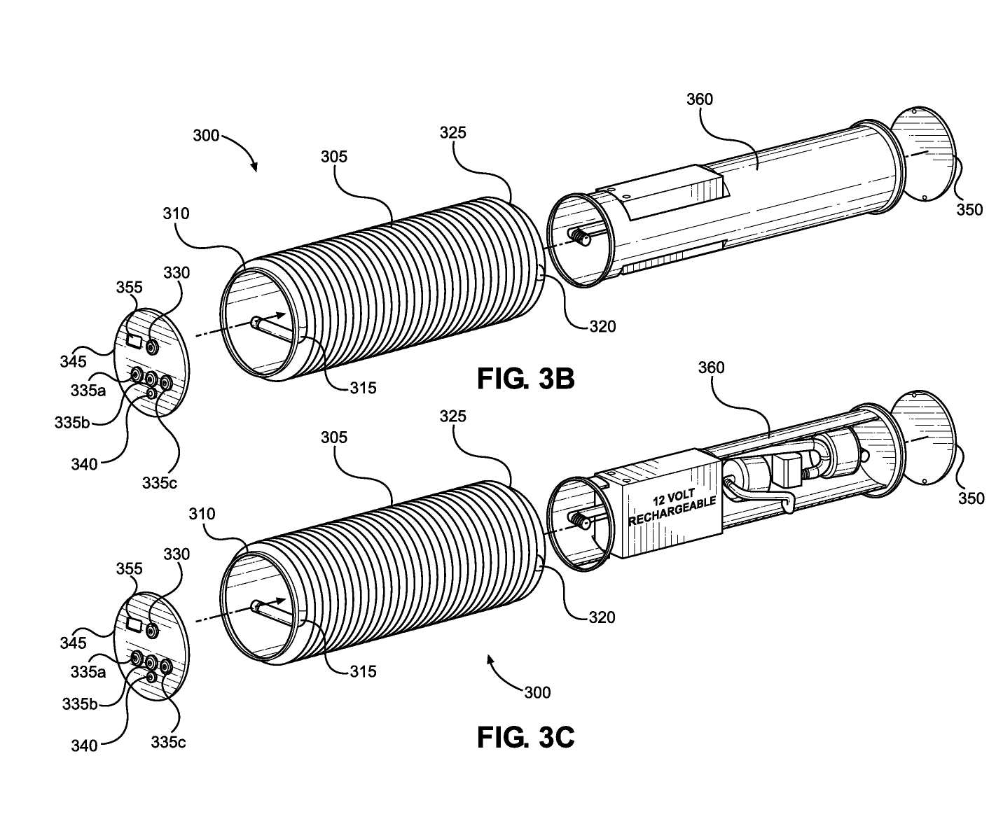

The fluid flowing through tubing 305 is circulated by a pump (shown in FIG. 4) that is controlled by power switch 330 integrated in end panel 345. Temperature adjustments to the fluid are controlled by temperature switches 335a-c mounted in end panel 345. Temperature switches 335a-c of FIG. 3 are integrated in end panel 345 and are shown with the representative settings “low,” “medium” and “high.” It should be understood that the number of settings may be more or less than three by adding or removing switches 335, or a single variable switch could be used to adjust the temperature across a temperature range. For example, a low temperature may be 100° F., a medium temperature may be 120° F. and a high temperature may be 140° F. An indicator light 340 and a charging port 355 are integrated in end panel 345.

In FIGS. 3B-3C, roller 300 is shown in a perspective break-out view of the component parts with a sleeve 360 within which internal parts are housed. Sleeve 360 may be made out of a rigid plastic or metal material and it allows the housing of roller 300 to be a formed in a single piece. All of the internal components can then be fitted within sleeve 360 (as seen in the cut-away view of FIG. 3C), and sleeve 360 may be slid into the hollow center core of roller 300. Details of the components that are fitted within sleeve 360 are shown in FIG. 4.

FIG. 4 shows the internal components of roller 300 that are housed within the hollow core of roller 300. In one embodiment shown in FIGS. 3B-3C, sleeve 360 is used within which the internal components are fitted. Alternatively, the internal components may be mounted in the hollow core of roller 300 without the use of sleeve 360. In that case, roller 300 may be formed of two or more exterior molded parts that are fitted together around the internal components.

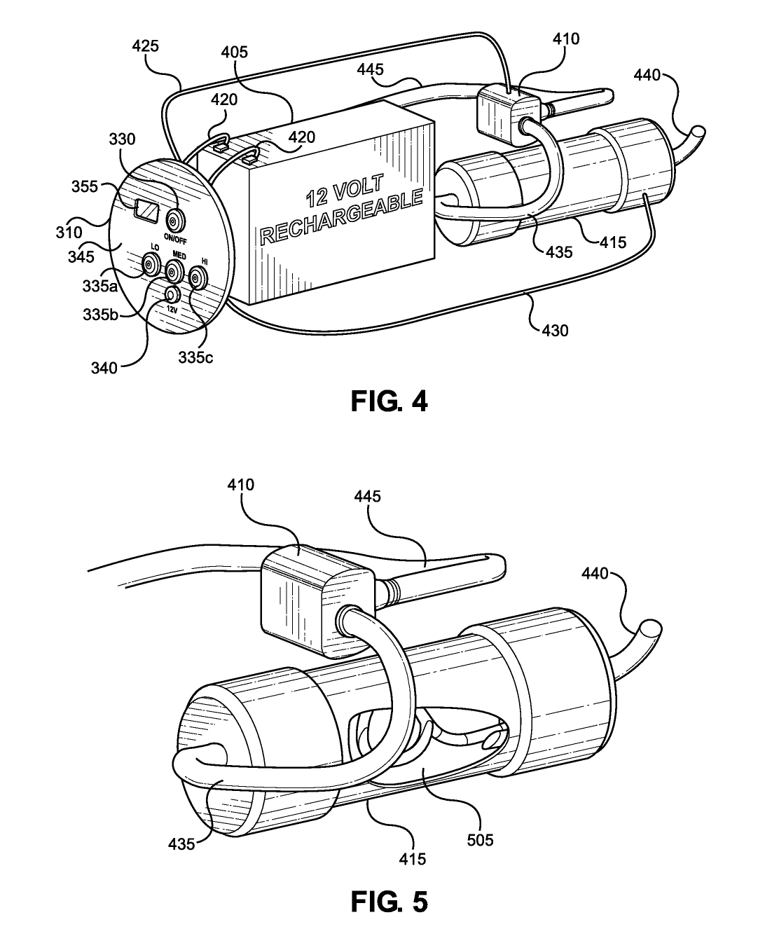

The internal components include a rechargeable battery 405, an electrically powered pump 410 and a heating chamber 415 within which a heating element is housed. Pump 410 is a standard positive displacement pump that is manufactured, for example, by Misol. FIG. 5 is a cut-away view of heating chamber 415 showing heating element 505 inside heating chamber 415. Heating element 505 is a standard resistance style heating coil of that is manufactured, for example, by RoadPro. Heating element 505 is used to heat the fluid in the system to a desired temperature which is adjusted using switches 335a-c. Rechargeable battery 405 supplies power to pump 410 and heating element 505. Battery 405 is recharged through charging port 355 to which a standard AC power cord 365 is plugged into an AC wall outlet. Once charged and during operation, indicator light 340 on end panel 345 indicates whether battery 405 is adequately charged to power pump 410 and heating element 505.

Power from battery 405 is supplied to pump 410 and heating element 505 through electrical connections shown as power wires 420 connecting battery 405 to power switch 330 and temperature switches 335a-c, pump wire 425 connecting on/off switch 330 to pump 410 and heat wire 430 connecting temperature switches 335a-c to heating element 505.

A closed loop is formed in the system through which fluid flows as it is pumped by pump 410. The closed loop includes: (1) a pump output tube 435 connected between an output of pump 410 and an input of heating chamber 415; (2) a heating output tube 440 connected between heating chamber 415 and entry port 315 of tubing 305; and (3) tubing 305 winding around the exterior of roller 300; and (4) a pump input tube 445 connected between exit port 320 of tubing 305 and an input of pump 410. The fluid may be water or it may be another fluid such as mineral oil or a glycol based heating fluid. The purpose of using an oil type fluid is that it is maintained at a higher temperature more efficiently than water thereby requiring less power supplied to heating element 505 over time conserving battery power and requiring charging less often. Further, the use of an oil type fluid instead of water inhibits bacterial growth in the internal components of the system and minimizes cleaning requirements over the life of the heated roller and its component parts, and it also prevents freezing should the unit be exposed to cold temperatures.

In operation, fluid is circulated through the closed loop system by pump 410. As the fluid flows through tubing 305 wound around the exterior of roller 300, tubing 305 delivers a heated contact area to a user as the heated contact area comes into contact with the user's skin during use of roller 300. The fluid is circulated through pump 410 which pumps the fluid out to output tube 435. From there, the fluid circulates through heating chamber 415 where it is heated to the desired temperature by heating element 505. As the fluid flows out of heating chamber 415, it passes into heating output tube 440 connected between heating chamber 415 and entry port 315 of tubing 305 at the first end 310 of roller 300. Once in tube 305, the fluid flows in a spiral pattern around the exterior of roller 300 before entering pump input tube 445. While it is flowing through tube 305 in a heated state after leaving heating chamber 415, the exposed surface area of tubing 305 contacts a user's skin during use delivering heat to the skin while the roller moves against the skin. Upon exiting tube 305 into exit port 320 at second end 325, the fluid is carried through pump input hose 445 where it re-enters the input of pump 410. The fluid is constantly circulated through this closed loop in a heated state as long as pump 410 is turned “on” using switch 330. The temperature of the fluid is determined by adjusting the heating element using switches 335a-c.

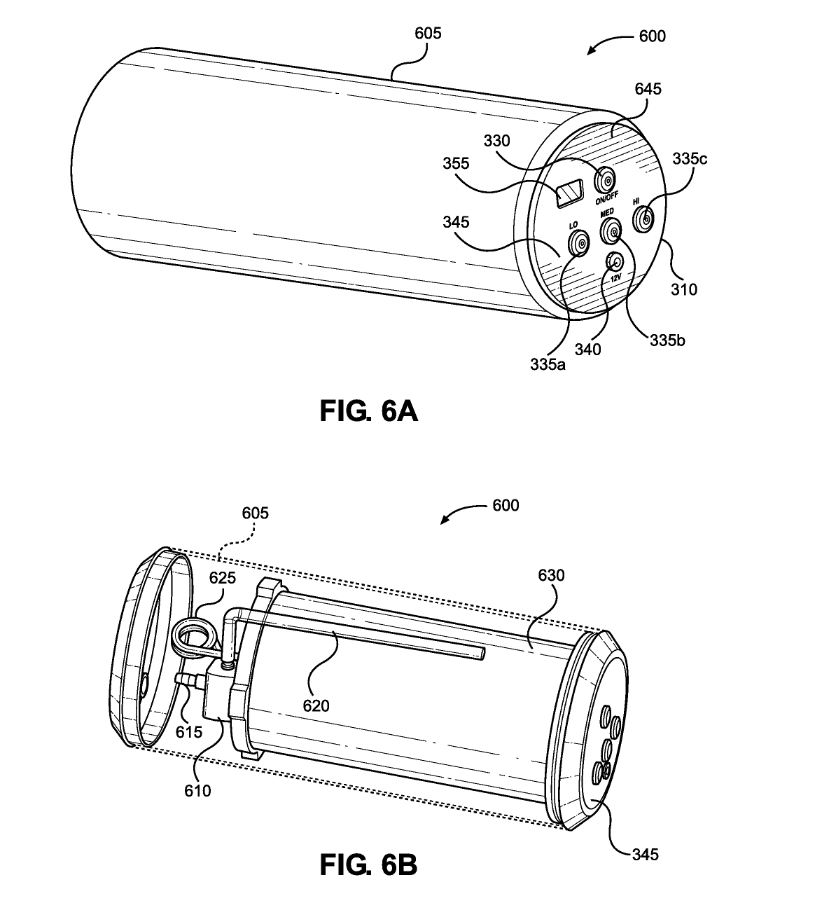

FIG. 6A is a perspective view of a second embodiment of a roller 600 in accordance with the present invention. In this embodiment, exterior surface 605 is formed of any rigid, durable material such as metal or mold-injected plastic. The metal or plastic could be of varying thickness, but a thickness of approximately ⅛ of an inch would be acceptable for the intended purpose. The controls in an end panel 345 are the same as those shown for the embodiment of FIGS. 3-5. A cut-away side view of this embodiment is shown in FIG. 6B. In this embodiment, the interior portion of roller 600 is filled with fluid. A pump 610 circulates fluid within the interior portion by drawing in the fluid through an intake tube 615 and outputting the fluid through an exit tube 620. A heating element 625 maintains the fluid at a desired temperature that is set according to the controls in end panel 345. The other internal components are housed in a dry tube 630 that is affixed at one end to end panel 345 such that the electronics can be controlled directly from end panel 345. The heated fluid circulating within the hollow interior portion of roller 600 surrounds dry tube 630 and contacts an interior surface of the external housing maintaining it a desired temperature for contact between the exterior surface of roller 600 and a user's skin.

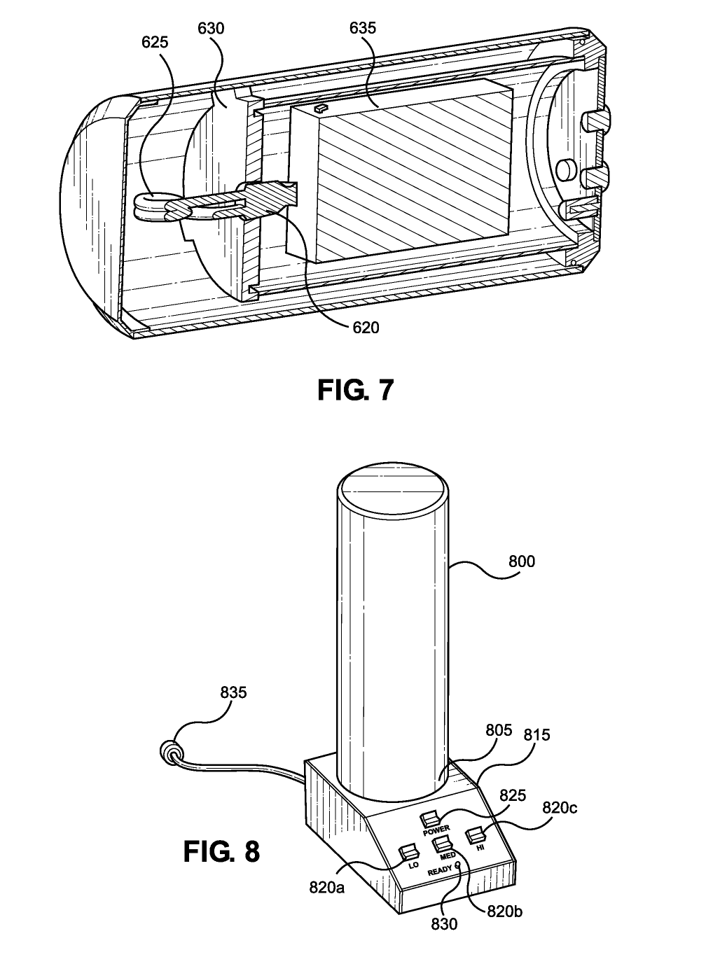

FIG. 7 shows the internal structure of roller 600. Heating element 625 is powered by a battery 635 that is the same as the one shown in the first embodiment. Battery 635 is housed in dry tube 630 so that it stays dry, along with the electrical interface 640 to heating element 625.

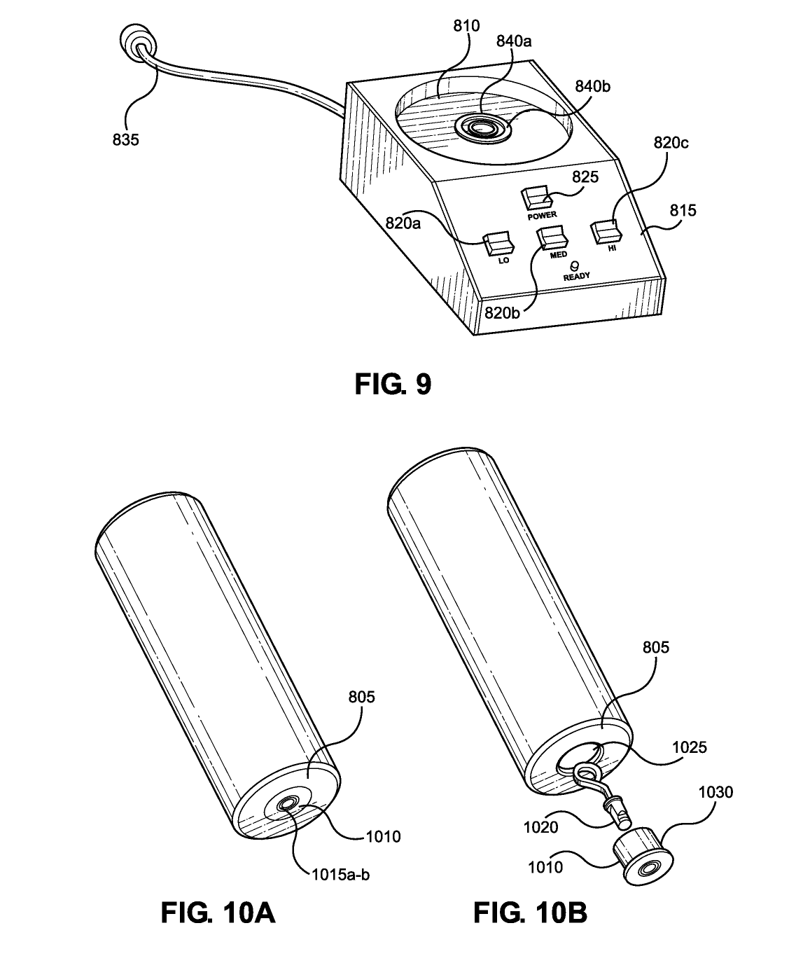

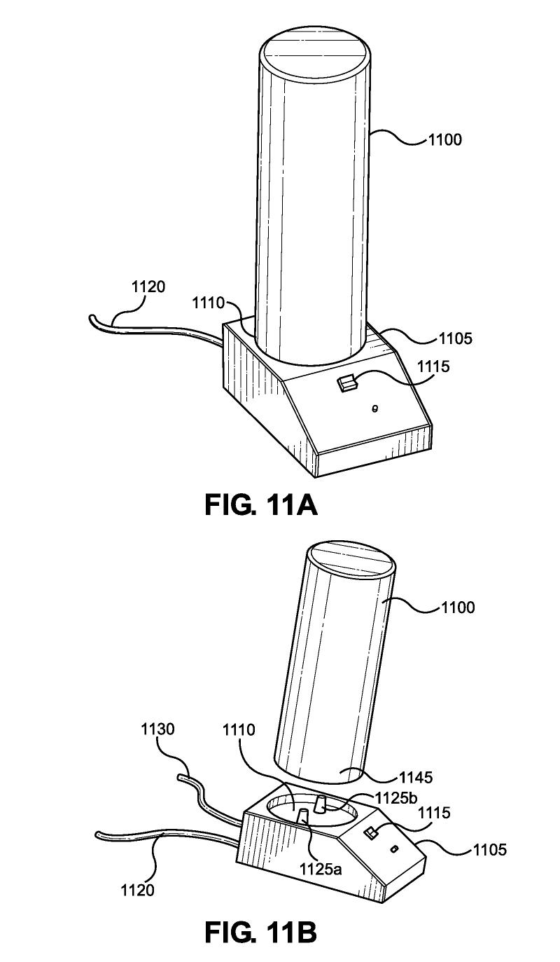

FIG. 8 is a perspective view of a third embodiment of a roller 800 in accordance with the present invention. In this embodiment, roller 800 is formed of a plastic or metal materials as with the other embodiments with a composition similar to roller 600 of FIGS. 6-7 and including a hollow core. The hollow core forms a container that is filled with fluid. In this embodiment, a first end 805 of roller 800 is adapted to mate with a roller interface 810 (see FIG. 9) of a heating station 815 such that first end 805 of roller 800 is accepted into roller dock or interface 810 of heating station 815 for heating fluid inside roller 800. Heating station 815 includes temperature switches 820a-c that set a temperature level—low, medium, high—to which the fluid inside of roller 800 is heated. Power button 825 controls power to heating station 815. Indicator light 830 indicates when roller 800 has reached the desired temperature and is ready for use. Power cord 835 plugs into standard wall outlet or alternatively could be powered by DC source.

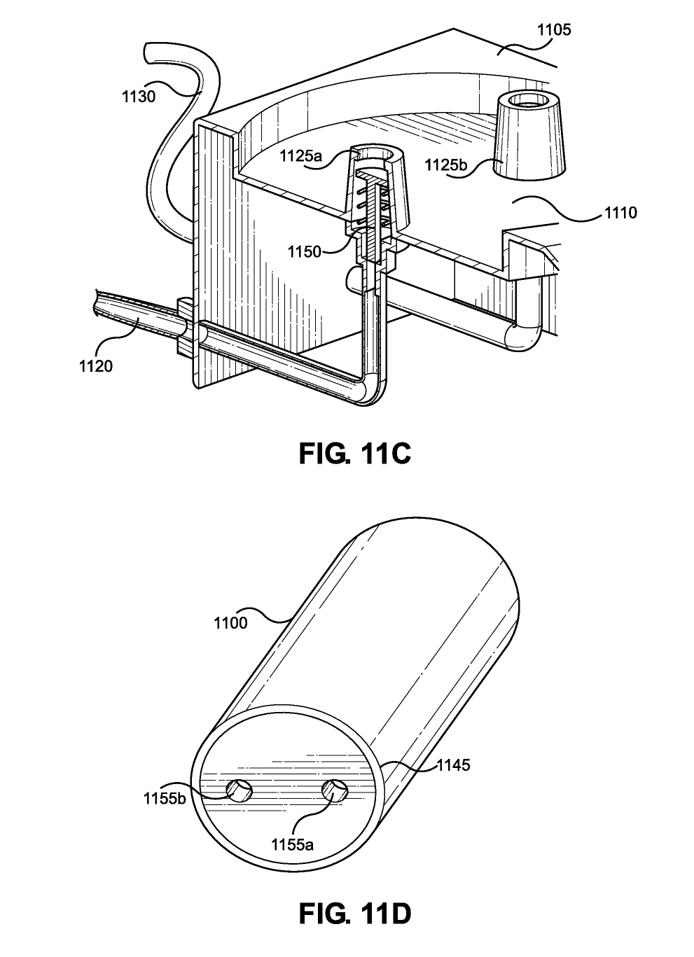

FIG. 9 shows heating station 815 of FIG. 8 without roller 800 in place in roller dock 810 of heating station 815. In this view, power ring elements 840a-b are visible. When power switch 825 is activated, charging station 815 is turned on and concentric power ring elements 840a-b provide power to heating element 1020 (see FIG. 10B). Heating element 1020 warms to an appropriate temperature as determined by temperature switches 820a-c. Power ring elements 840a-b are configured in a concentric pattern so that roller 800 does not need to be specifically aligned with placed in heating station 815. Power ring elements 840a-b are preferably recessed in heating station 815 to minimize the likelihood of a short circuit.

FIGS. 10A-B are two perspective views of a heating element 845 of roller 800 as shown in FIGS. 8-9. In the view of FIG. 10A, roller 800 is shown with first end 805 in a form as it would be used. In this view, roller base 805 is visible with sealed cap 1010 in place over the hollow internal core of roller 800 where fluid is contained. Cap rings 1015 align with power ring elements 840a-b when roller 800 is placed in roller dock 810 on heating station 815 during operations to supply power through cap rings 1015 to heating element 1020 (see FIG. 10B).

In the view of FIG. 10B, cap 1010 is shown removed from roller 800 and heating element 1020 is visible on the inside portion of cap 1010 where that it may be inserted into the hollow core of roller 800 so that it is contact with the fluid contained within the core. Cap 1010 forms a water-tight seal when it is inserted into opening 1025 using threads 1030 along the sides of cap 1010. Alternatively, cap 1010 may be sealed in opening 1025 by using a snap-in design in which cap 1010 snaps into place. Once cap 1010 is removed from opening 1025, fluid may be replaced and the hollow core forming the container for the fluid may be cleaned.

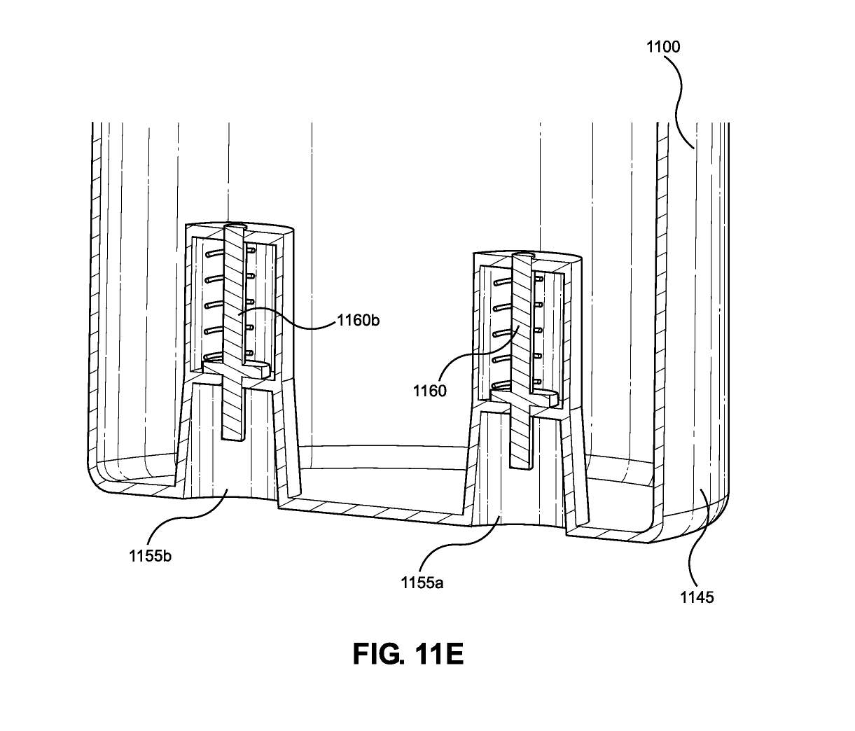

FIGS. 11A-B are two perspective views of a fourth embodiment of a roller 1100 in accordance with the present invention. FIG. 11A shows a roller 1100 fitting into a station 1105 in a roller dock or interface 1110. In this embodiment, all heating or cooling is performed at a source of the fluid. Fluid of a desired temperature, which may be hot, warm or cold, is input to station 1105 via hose 1120 when activation button 1115 is depressed on station 1105. Roller 1100 is essentially a large water bottle and may be filled from input hose 1120.

In the view of FIG. 11B, roller 1100 is shown removed from roller dock 1110. A pair of fluid ports 1125a, 1125b that incorporate one-way valves prevent fluid loss when roller 1100 is inserted into or removed from roller dock 1110. Fluid input port 1125a is connected to input hose 1120 and fluid output port 1125b is connected to output hose 1130. A source of fluid (e.g. water or oil) can be connected to hose 1120 and output hose 1130 can be connected to a drain. When fluid of a desired temperature is provided to fill an interior hollow portion of roller 1100, a valve on fluid input port 1125a is opened and fluid flows into roller 1100. Any excess fluid is circulated out through output port 1125b and into hose 1130 to the drain. In this way, fluid of the appropriate temperature fills roller 1100.

FIG. 11C shows a detailed view of fluid ports 1125a of station 1105. A spring-loaded valve 1150 is seated inside ports 1125a, 1125b permitting fluid to flow from input tube 1120 through input port 1125a into roller 1100 when it is placed in dock 1110.

FIGS. 11D-E shows fluid ports 1155a-b on a first end 1145 of roller 1100. Each port is similar in structure to the one-way ports 1125a-b of station 1105 and includes a spring loaded valve 1160a-b that is opened when in place in roller dock 1110 and automatically closed when roller 1100 is removed from dock 1110.

While the invention has been described with respect to the figures, it will be appreciated that many modifications and changes may be made by those skilled in the art without departing from the spirit of the invention. Any variation and derivation from the above description and drawings are included in the scope of the present invention as defined by the claims.

What is claimed is:

1. A heated roller comprising:
a roller body having an exterior surface defining a substantially cylindrical exterior shape and an interior space defining a hollow roller body core;
a power supply positioned in the roller body core;
a pump positioned in the roller body core and powered by the power supply that pumps fluid input to the pump;
a heating chamber in fluid connection with the pump;
a heating element positioned in the heating chamber and powered by the power supply that heats fluid circulated through the heating chamber;
a closed loop through which fluid is circulated comprising:
a roller tube affixed to and covering the exterior surface of the roller body;
an input tube; and
an output tube;
a control panel accessible on the exterior surface of the roller body comprising at least one switch, the at least one switch having a first state and a second state, wherein in a first state no power is supplied from the power supply to the pump and the heating element, and in a second state, power is supplied from the power supply to the pump and the heating element; and
wherein, when the at least one switch is in the second state, the pump pumps fluid through the heating chamber and the closed loop, and further wherein the heating element heats fluid circulating through the heating chamber such that heated fluid in the roller tube transfers heat to an exterior surface of the roller tube, and when the exterior surface of the roller tube contacts a user, heat is transferred to the user at an area of contact between the exterior surface of the roller tube and the user.

2. The apparatus of claim 1 wherein the at least one switch has a plurality of settings including: (a) an “off” setting; (b) a first setting at which the heating element is set to a first temperature; and (c) a second setting at which the heating element is set to a second temperature.

3. The apparatus of claim 1 further comprising a charging port into which a power cord is plugged to charge the power supply.

4. The apparatus of claim 1 wherein the roller tube is made of flexible material that depresses when pressure is applied and returns to original form when pressure is removed.

5. The apparatus of claim 1 wherein an exterior diameter of the roller tube is in the approximate range of 11 mm to 16 mm.

6. The apparatus of claim 1 further comprising a first end panel housing at least one operational switch for controlling the roller.

7. The apparatus of claim 6 further comprising a sleeve within which the power supply, pump, heating chamber and heating element are fitted, wherein the sleeve is removably positioned in the hollow roller body core during operation.

8. The apparatus of claim 7 wherein the first end panel or a second end panel is removable affixed to the roller such that the removable end panel is removed, the sleeve may be inserted in the hollow roller body core and the removable end panel is re-affixed to the roller.

9. A heated roller comprising:
a roller body having an exterior surface defining a substantially cylindrical exterior shape and an interior space defining a hollow roller body core;
a dry tube positioned in the hollow roller body core that houses a power supply;
a pump positioned in the roller body core and powered by the power supply that circulates fluid input to the pump within the hollow roller body core;
a heating element positioned in the roller body core and powered by the power supply that heats fluid circulated through the hollow roller body core by the pump;
a control panel accessible on the exterior surface of the roller body comprising at least one switch, the at least one switch having a first state and a second state, wherein in a first state no power is supplied from the power supply to the pump and the heating element, and in a second state, power is supplied from the power supply to the pump and the heating element; and
wherein, when the at least one switch is in the second state, the pump pumps fluid through the roller body core.

10. The apparatus of claim 9 wherein the at least one switch has a plurality of settings including: (a) an “off” setting; (b) a first setting at which the heating element is set to a first temperature; and (c) a second setting at which the heating element is set to a second temperature.

11. The apparatus of claim 9 further comprising a charging port into which a power cord is plugged to charge the power supply.

12. The apparatus of claim 9 wherein the roller is made of a malleable material that depresses when pressure is applied and returns to original form when pressure is removed.

13. The apparatus of claim 9 further comprising a first end panel housing at least one operational switch for controlling the roller.

14. The apparatus of claim 9 further comprising at least one temperature setting switch for adjusting the temperature of the heating element.

15. The apparatus of claim 9 wherein the hollow roller body core is filled with fluid that contacts an interior surface which conducts thermal energy from the fluid to the exterior surface.

16. The apparatus of claim 9 further comprising a removal end panel that is secured to an end of the roller and that is sealed to maintain the fluid in the hollow roller body core.

17. A heated roller system comprising:
a roller body having an exterior surface defining a substantially cylindrical exterior shape and an interior space defining a hollow roller body core wherein the hollow roller body core is filled with fluid;
a heating element affixed to an end cap that is removably affixed to an end cap of the roller body;
a station for heating the fluid in the hollow roller body core, comprising:
a docking area into which an end of the roller is docked;
a power connection positioned in the docking area that contacts the end cap and powers the heating element when the roller is docked in the docking area;
at least one switch for powering the heating element and setting the temperature of the heating receiver; and
wherein, when the at least one switch is in an on state, the heating receiver temperature is set to a desired level;
further wherein, power is conducted to the heating element such that the heating element conducts thermal energy to the fluid in the hollow roller body core to raise a temperature of the fluid, which in turn heats the exterior surface; and
further wherein, upon the temperature of the fluid being raised, the roller is removed from the station for use while the temperature of the exterior surface is heated.

18. The apparatus of claim 17 wherein the roller is made of a malleable material that depresses when pressure is applied and returns to original form when pressure is removed.

19. The apparatus of claim 17 further comprising at least one temperature setting switch for adjusting the temperature of the heating element.

20. The apparatus of claim 17 wherein the hollow roller body core is filled with fluid that contacts an interior surface which conducts thermal energy from the fluid to the exterior surface.
